(19) United States
(12) Patent Application Publication
(10) Pub. No.: US 2012/0086343 A1
(43) Pub. Date: Apr. 12, 2012

(54) LIGHT ADJUSTABLE LAMP (Amended)

(75) Inventors: Jiaqing Zhuang, Zhangzhou (CN); Jingkun Xu, Zhangzhou (CN); Kuoliang Lee, Taipei (TW); Shun Yung Chang, Taipei (TW)

(73) Assignee: TSANN KUEN (ZHANGZHOU) ENTERPRISE CO., LTD., Fujian (CN)

(21) Appl. No.: 13/378,073

(22) PCT Filed: Jun. 13, 2010
(86) PCT No.: PCT/CN2010/073960

§ 371 Date: Dec. 14, 2011

(30) Foreign Application Priority Data
Jun. 17, 2009 (CN) 200910112098.9

(51) Int. Cl. H05B 37/02

(52) U.S. Cl. 315/132; 315/292

(57) ABSTRACT

A light adjustable lamp, related to the lighting facilities has a power module supplying power to a driving unit which is controlled by a Pulse Width Modulation signal. The driving unit supplies power to the lamp; the power module supplies power to the touch signal converter and the microprocessor control unit; the touch signal converter receives the sensing signal of on, off or level from the sense key on the touch sensing keyboard, and converts the sensing signal to the corresponding control level signal to the microprocessor control unit; the microprocessor control unit analyses the control level signal from the touch signal converter and transmits the corresponding Pulse Width Modulation signal to control the driving unit to cut off the power to the lamp or supply power to the lamp with active current in provided level.

### FIELD OF THE INVENTION

The present invention relates to the light facility, especially to the light facility with LED.

### BACKGROUND OF THE INVENTION

The existing filament lamp is light adjusted with voltage regulation. But the lamp of LED is unsuitable to light adjusted by regulating the voltage. The industries try to adjust the light of LED lamp by regulating the duty cycle of the pulsating direct current for the LED lamp to change the active current for the LED lamp. For example, the Chinese patent publication number CN201114962Y with the patent No. 200720075227.8 is provided with a technical proposal of A Touch Switch Light Adjuster. The switch power module supplies power to the touch signal control module and the switch output module, the touch signal control module receives the operation signal from the touch sensing key input module, and then controls the switch output module to connect to the mains supply and to the light adjust power module. The light adjust power module supplies power to the light adjust module and the light adjust output loop (the driving unit). After receiving the operation signal from the knob input module, the light adjust module controls the light adjust module to change the pulse-width of the square wave output to change the duty cycle of the pulsating direct current to the LED light from the light adjust output loop. So the light is adjusted. But the existing technical proposal has the disadvantages below: firstly, the controlling is achieved by the combination of the touch switch and the knob, which has bad operation; secondly, the internal power supply system is consisted of the switch power system, the switch output module and the light adjust power module, which is structural complex with the limited service life and reliability due to the usage of the relay in the switch output module. So, the existing technology is unsuitable for the house or service site of premium quality.

### SUMMARY OF THE INVENTION

The present invention is provided with a light adjustable lamp with easy operation and high reliability.

The technical proposal of the present invention is:

A light adjustable lamp, the power module supplies power to the driving unit controlled by the Pulse Width Modulation signals, and the driving unit supplies power to the lamp; the power module supplies power to the touch signal converter and the microprocessor control unit; the touch signal converter receives the sensing signal of on, off or level signals from the sensing key on the touch sensing keyboard; the microprocessor control unit analyses the control level signal from the touch signal converter to transmit the corresponding Pulse Width Modulation signal to control the driving unit to cut off the power to the lamp or supply power to the lamp with active current in provided level. When the finger of a person contacts one sensing key of the touch sensing keyboard, the touch signal converter transmits the corresponding signal to the microprocessor control unit. The microprocessor control unit controls the driving unit to operate the switch and the light adjust of the main lamp.

Specially, the power module supplies power for the level indicating unit, the microprocessor control unit transmits the current level control signal to the level indicating unit to light up the corresponding indicating light on the level indicating unit. The user can read the current level state by observing the indicating light of the level indicating unit to make sure that whether the lightness of the main lamp is needed to adjust further.

In the preferred embodiment: the touch signal converter is capacitive touch sensing integrated circuit module. The connection of the capacitive touch sensing integrated circuit module with the sensing keys on the touch sensing keyboard and the microprocessor control unit is simple, which is propitious for assembly. The service life is promoted and the reliability is high.

Specially: the main lamp is LED light. The power supply of the pulse width active current is suitable for the working characteristic of the LED light, making the light adjust of the LED light into full play.

The present invention of a light adjustable lamp is applied a power module to power supply for each unit, thereinto the touch signal converter receives the sensing signal of on, off or level from the sensing keys on the touch sensing keyboard and converts the sensing signal to corresponding control level signal to transmit to the microprocessor control unit; the microprocessor control unit analyses the control level signal from the touch signal converter and transmits the corresponding Pulse Width Modulation signal to the driving unit to control the power supply state for the Pulse Width Modulation lamp. The structure is simple with clear function of each unit, easily for integrated circuit module. So the serving life and the reliability are promoted. Especially, with touch sensing keyboard to deal with the switch and the switch of the main lamp, the user sliding contacts or pressing contact the sensing keys with a finger to achieve the corresponding controlling and the sliding operation interface.

### BRIEF DESCRIPTION OF THE DRAWINGS

FIG. 1 illustrates the circuit block diagram of the embedment of the present invention;

FIG. 2 illustrates the circuit structure of the driving unit in the embodiment of the FIG. 1;

FIG. 3 illustrates the connection of the touch sensing keyboard, the touch signal converter and the microprocessor in the embodiment of the FIG. 1;

FIG. 4 illustrates the circuit structure of the level indicating unit in the embodiment of the FIG. 1;

FIG. 5 illustrates the control flow of the microprocessor control unit in the embodiment of the FIG. 1.

### DETAILED DESCRIPTION OF THE EMBODIMENTS

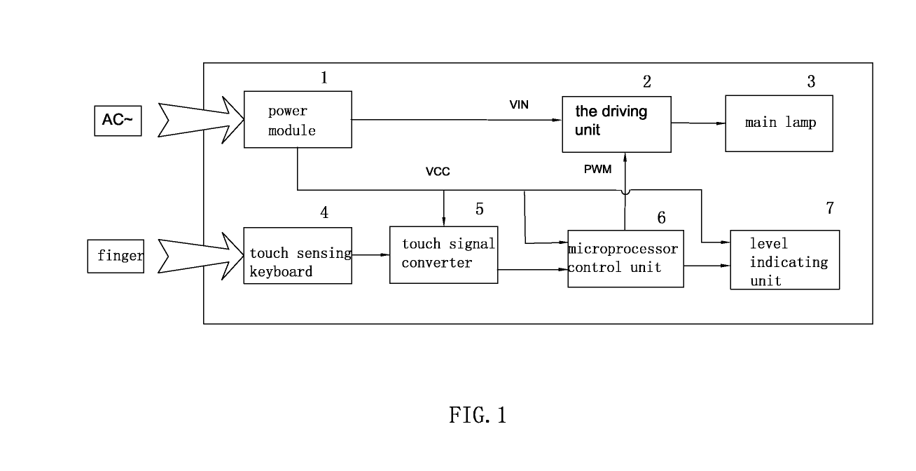

The circuit block diagram of one of the embodiment of the present invention of a light adjustable lamp is provided, see the FIG. 1. The light adjustable lamp is a table lamp, the housing of which is disposed with a circuit board. There are a power module 1, a driving unit 2, a touch signal converter 5 and a microprocessor control unit 6 disposed on the circuit board. A touch sensing keyboard 4 and a level indicating unit 7 are disposed on the panel of the housing.

The power module 1 has the AC power, the rectifier circuit and the filter circuit. The AC mains power (AC) is converted to two DC output VIN and VCC; the first DC output VIN supplies power to the driving unit 2, and the second DC output VCC supplies power to the touch signal converter 5, the microprocessor control unit 6 and the level indicating unit 7.

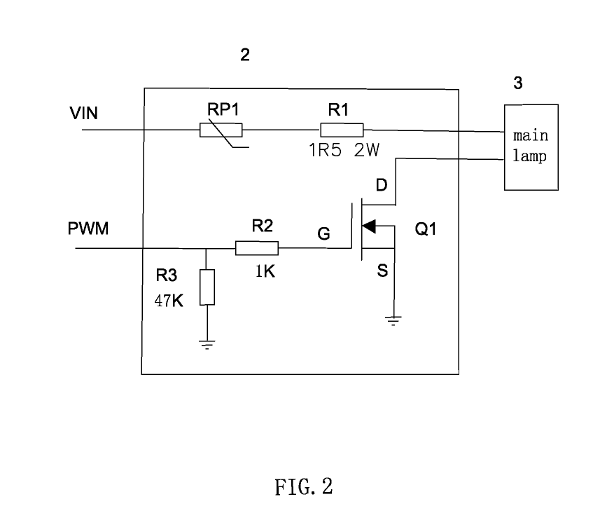

The circuit structure of the driving unit 2 is figured as the FIG. 2. The power input of the driving unit 2, that is the front end of the piezoresistor RP1, is connected to the first DC output VIN of the power module 1. The rear end of the piezoresistor RP1 is series connected to the current limit resistor R1 and then connected to the power end of the main lamp 3 consisted of LED lights. The main lamp 3 may apply with filament lamp. The control input end of the driving unit 2, that is the joint of the biasing resistor R3 and the current limit R2, is connected to the Pulse Width Modulation signal output PWM of the microprocessor control unit 6. The other end of the biasing resistor R3 is grounded. The other end of the current limit resistor R2 is connected to the grid G of the field-effect tube Q1. The source of the field-effect tube Q1 is grounded, and the drain is connected to the other power end of the LED main lamp 3. The type of the field -effect tube Q1 is S2306 in this embodiment.

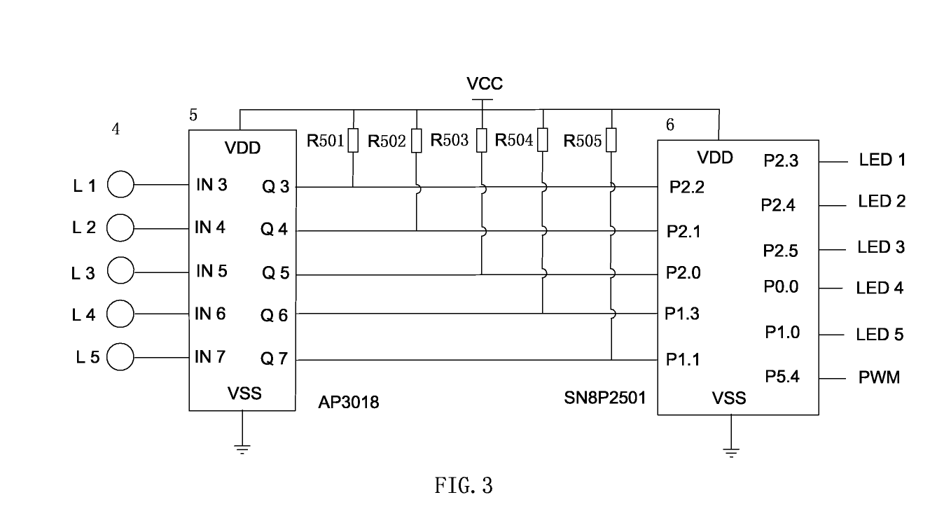

Refer to the FIG. 3:

The touch sensing keyboard 4 has five sensing key L1, L2, L3, L4, and L5. They are isolated copper foil wires disposed between the two layers of insulation materials separately. Every neighbor two forms a capacity. The leading end of each is connected to the corresponding signal input end of the touch signal converter 5.

The touch signal converter 5 applies the capacitive type touch sensing IC module of type number ap3018DN made by the alpha pacific Technologies Co.,Ltd. The signal input end IN3, IN4, IN5, IN6, IN7 of the touch signal converter 5 are connected to the corresponding sensing key L1, L2, L3, L4, and L5 in series. The outputs Q3, Q4, Q5, Q6, Q7 of the touch signal converter 5 corresponding to the sensing key L1, L2, L3, L4, L5 are connected to the detecting ends of the microprocessor control unit 6. There are resistors R501, R502, R503, R504, R505 disposed between the outputs Q3, Q4, Q5, Q6, Q7 of the touch signal converter 5 and the DC power VCC.

The microprocessor control unit 6 is the normal microprocessor, which is applied SN8P2501 in this embodiment. The detecting input ends P2.2, P2.1, P2.0, P1.3, and P1.1 are connected to the outputs Q3, Q4, Q5, Q6, and Q7 of the touch signal converter 5 in series. The output end P2.3, P2.4, P2.5, P0.0 and P1.0 as the first level control output LED1, the second level control output LED2, the third level control output LED3, the fourth level control output LED4, the fifth level control output LED5, are connected to the corresponding level input ends of the level indicating unit 7. The output P5.4 of the microprocessor 6 served as the Pulse Width Modulation signal output PWM is connected to the control input of the driving unit 2.

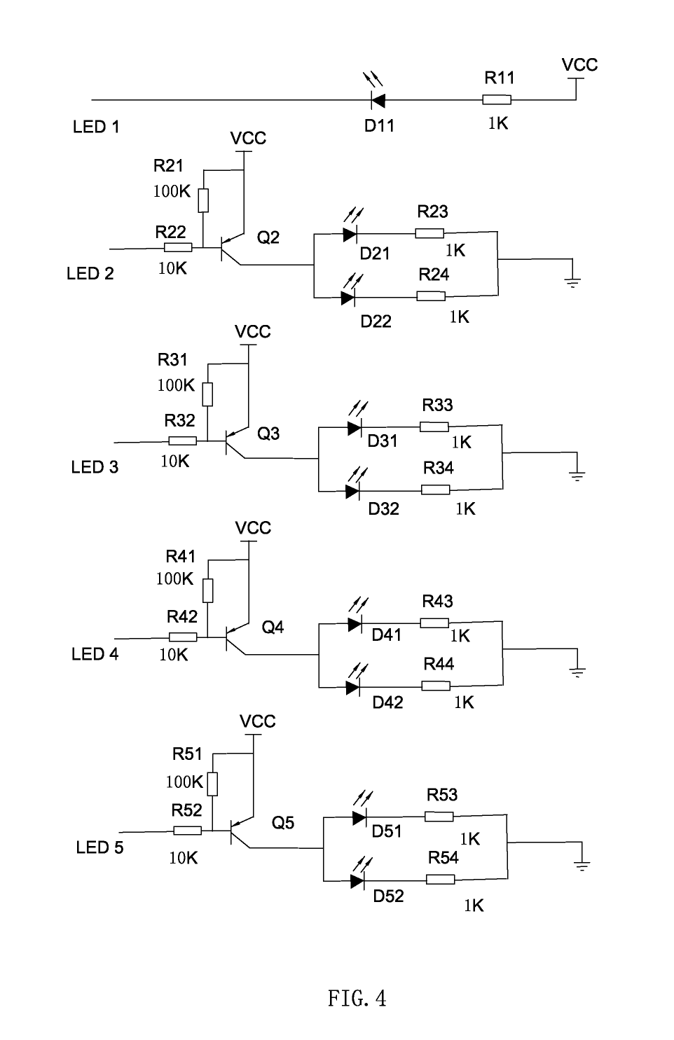

The circuit structure of the level indicating unit 7 is figured as FIG. 4: the level indicating unit 7 has five sets of LED indicating light.

The first set of the LED indicating light has only a LED D11, the LED D11 and the current limiting resistor R11 are series connected between the second DC output VCC of the power module 1 and the first level control output LED1 of the microprocessor control unit 6.

The second set of the LED indicating light has two LED D21 and L22. The transistor Q2, the biasing resistor R21 and the current limit resistor R22 are made up to be the power supply switch of the second set of LED indicating light. The emitter of the transistor Q2 is connected to the end of the second DC output VCC and the biasing resistor R21, and the base is connected to the other end of the biasing resistor R21 and the rear end of the current limit resistor R22. The second level control output LED2 of the microprocessor control unit 6 is connected to the front end of the input of the power supply switch, which is the current limit resistor R22. The collector of the transistor Q2 is connected to the positive poles of the two LED D21 and D22. The negative poles of the two LED D21 and D22 are grounded separately with respective current limit resistor R23 and R24.

The third set of the LED indicating light is two LED light D31 and D32. The transistor Q3, the biasing resistor R31 and the current limit resistor R32 are made up to be the power supply switch of the third set of LED indicating light. The third level control output LED3 of the microprocessor control unit 6 is connected to the front end of the input of the power supply switch, which is the current limit resistor R32.

The fourth set of the LED indicating light is two LED light D41 and D42. The transistor Q4, the biasing resistor R41 and the current limit resistor R42 are made up to be the power supply switch of the fourth set of LED indicating light. The fourth level control output LED4 of the microprocessor control unit 6 is connected to the front end of the input of the power supply switch, which is the current limit resistor R42.

The fifth set of the LED indicating light is two LED light D51 and D52. The transistor Q5, the biasing resistor R51 and the current limit resistor R52 are made up to be the power supply switch of the fifth set of LED indicating light. The fifth level control output LED5 of the microprocessor control unit 6 is connected to the front end of the input of the power supply switch, which is the current limit resistor R52.

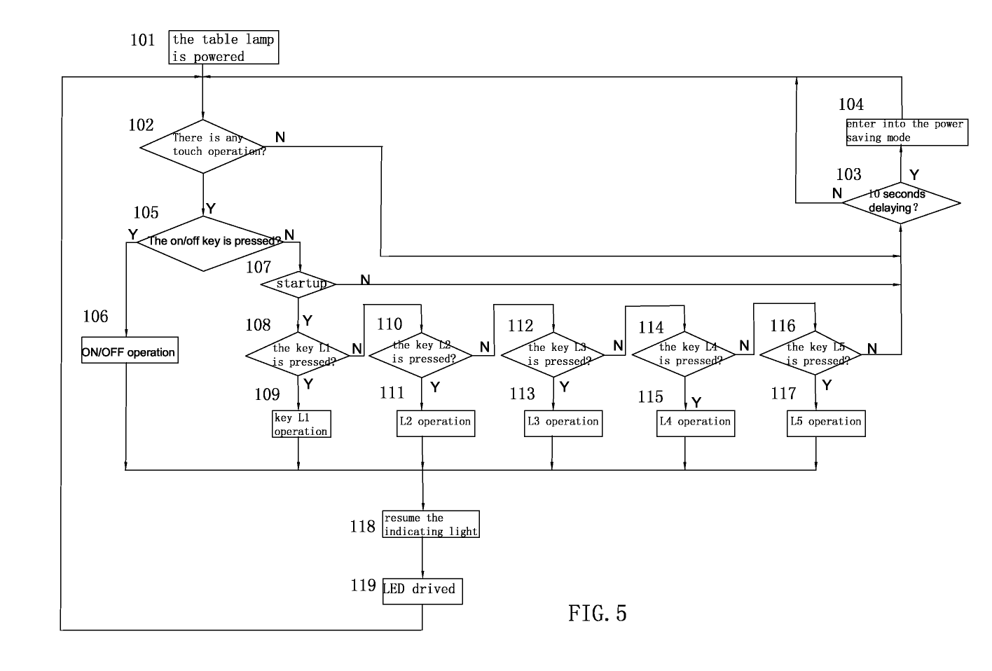

The control flow of the microprocessor control unit 6 during working is figured as the FIG. 5;

Step 101: the table lamp is powered, and the AC mains power supplies power to the power module 1. The first DC output VIN of the power module 1 supplies power to the driving unit 2, and the second one VCC supplies power to the touch signal converter 5, the microprocessor control unit 6 and the level indicating unit 7.

Step 102: the microprocessor control unit 6 detects the self detecting input to check that whether there is touch signal. If the sensing key L1, L2, L3, L4, L5 on the touch sensing keyboard 4 doesn't receive the sliding contact or pressing contact, that no touch signal is existed, high level VCC output will be transferred from the convert output corresponding to each sensing key on the touch signal converter 5. But if one of the sensing keys receives the sliding contract or pressing contact, that there is touch signal, the convert output corresponding to each sensing key on the touch signal converter 5 will be transferred to be zero (GND); once the finger is off, that the touch signal is disappeared, the convert output corresponding to each sensing key on the touch signal converter 5 will resume to high level VCC. If there is touch signal, turn to step 105, if not, turn to the step 103.

Step 103: the microprocessor control unit 6 detects the self counter of 10 seconds delaying; if the counting of the counter reaches to 10 seconds without touch signal, turn to the step 104; if the counting falls short of 10 seconds, turn to the step 102 to wait for the touch signal.

Step 104: enter to the power saving mode with actuating the microprocessor control unit intermittently.

Step 105: the microprocessor control unit 6 detects the self lowest order (corresponding to the sensing key L1) detecting output to check that whether there is touch signal of finger long sliding contact or pressing contact to the sensing key L1. If there is touch signal of finger long sliding contact or pressing contact to the sensing key L1, turn to the step 106; if not, turn to the step 107.

Step 106: The microprocessor control unit 6 detects the self startup state flag storage cell. If the startup state flag storage cell is saved to be shutdown, change the state to be startup and set the first (the lowest) level indicating state flag storage cell to be 0 (light up), and the others to be 0 (cut off). If the startup state flag storage cell is saved to be startup, change the state to be shutdown and set the first (the lowest) level indicating state flag storage cell to be 1 (cut off), and the others to be zero (light up). Turn to the step 118.

Step 107: The microprocessor control unit 6 detects the self startup state flag storage cell. If the startup state flag storage cell is saved to be startup, turn to the step 108. If not, turn to the step 103.

Step 108: the microprocessor control unit 6 detects the self lowest (corresponding to the sensing key L1) detecting input to check that whether there is touch signal of finger short sliding contact or pressing contact to the sensing key L1. If there is touch signal of finger short sliding contact or pressing contact to the sensing key L1, turn to the step 109; if not, turn to the step 110.

Step 109: The microprocessor control unit 6 sets the first (the lowest) level indicating state flag storage cell to be 0 (light up), and the others to be 0 (cut off); turn to the step 118.

Step 110: the microprocessor control unit 6 detects the self second (corresponding to the sensing key L2) detecting input to check that whether there is touch signal of finger sliding contact or pressing contact to the sensing key L2. If there is touch signal of finger sliding contact or pressing contact to the sensing key L2, turn to the step 111; if not, turn to the step 112.

Step 111: The microprocessor control unit 6 sets the first (the lowest) level indicating state flag storage cell to be 0 (light up), the second (the sub-lowest)level indicating state flag storage cell to be 1 (light up) and the others to be 0 (cut off); turn to the step 118.

Step 112: the microprocessor control unit 6 detects the self third (corresponding to the sensing key L3) detecting input to check that whether there is touch signal of finger sliding contact or pressing contact to the sensing key L3. If there is touch signal of finger sliding contact or pressing contact to the sensing key L3, turn to the step 113; if not, turn to the step 114.

Step 113: The microprocessor control unit 6 sets the first (the lowest) level indicating state flag storage cell to be 0 (light up), the second (the sub-lowest) and the third (the midst)level indicating state flag storage cell to be 1 (light up) and the others to be 0 (cut off); turn to the step 118.

Step 114: the microprocessor control unit 6 detects the self fourth (corresponding to the sensing key L4) detecting input to check that whether there is touch signal of finger sliding contact or pressing contact to the sensing key L4. If there is touch signal of finger sliding contact or pressing contact to the sensing key L4, turn to the step 115; if not, turn to the step 116.

Step 115: The microprocessor control unit 6 sets the first (the lowest) level indicating state flag storage cell to be 0 (light up), the second (the sub-lowest), the third (the midst)level and the fourth (the sub-highest)indicating state flag storage cell to be 1 (light up) and the fifth (the highest) to be 0 (cut off); turn to the step 118.

Step 116: the microprocessor control unit 6 detects the self fifth (corresponding to the sensing key L5) detecting input to check that whether there is touch signal of finger sliding contact or pressing contact to the sensing key L5. If there is touch signal of finger sliding contact or pressing contact to the sensing key L5, turn to the step 117; if not, turn to the step 103.

Step 117: The microprocessor control unit 6 sets the first (the lowest) level indicating state flag storage cell to be 0 (light up), and the others to be 1 (light up); turn to the step 118.

Step 118: the microprocessor control unit 6 transmits the data saved in the self each level indicating state flag storage cell to the level indicating unit 7 through the corresponding level control output, that is the microprocessor control unit 6 transmitting the current level control signal to the level indicating unit 7 to light up the LED indicating light according to the level indicating unit 7. Turn to the step 119.

We set the fifth level indicating state flag storage cell to be the highest, and the first one to be the lowest. In this step: if the data in the level indicating state flag storage cell is 00001, it is situated in the shutdown state and the five set of the LED indicating light are situated in the cut off state. If the data in the level indicating state flag storage cell is 00000, it is situated in the first level state and the first set of the LED indicating light is light up and the others are situated in the cut off state. If the data in the level indicating state flag storage cell is 00010, it is situated in the second level state, the first and the second set of the LED indicating light are light up and the other three sets are situated in the cut off state. If the data saved in the level indicating state flag storage cell is 00110, it is situated in the third level state, the first, the second and the third set of the LED indicating light are light up and the other two sets are situated in the cut off state. If the data in the level indicating state flag storage cell is 01110, it is situated in the fourth level state, the first to the fourth set of the LED indicating light are light up and the fifth set is situated in the cut off state. If the data in the level indicating state flag storage cell is 11110, it is situated in the fifth level state, and the five sets of the LED indicating light are light up.

Step 119: the microprocessor control unit 6 converts the level the state data saved in the level indicating state flag storage cell represented to the corresponding pulse-width modulating signal, and transmits to the driving unit 2 through the Pulse Width Modulation signal output PWM to control the driving unit 2 to cut off the power supply for the LED main lamp 3 or supply power to the lamp with active current in provided level. Turn to the step 102.

In this step: if the data saved in the level indicating state flag storage cell is 00001, that is the shutdown state, the microprocessor control unit 6 transmits zero to the driving unit through the pulse width signal output PWM to control the driving unit 2 to cut off the power supply for the LED main lamp 3. Then the LED main lamp 3 is unlighted. If the data saved in the level indicating state flag storage cell is 00000, that is the first level state, the microprocessor control unit 6 transmits zero, which is the longest Pulse Width Modulation signal, to the driving unit 2 through the pulse width signal output PWM to control the driving unit 2 to supply power to the LED main lamp 3 with the active current in the provided first level. So the LED main lamp 3 is lighted up in the weakest lightness. If the data saved in the level indicating state flag storage cell is 00010, that is the second level state, the microprocessor control unit 6 transmits zero, which is the sub-longest Pulse Width Modulation signal, to the driving unit 2 through the pulse width signal output PWM to control the driving unit 2 to supply power to the LED main lamp 3 with the active current in the provided second level. So the LED main lamp 3 is lighted up in the sub-weakest lightness. If the data saved in the level indicating state flag storage cell is 00110, that is the third level state, the microprocessor control unit 6 transmits zero, which is the midst Pulse Width Modulation signal, to the driving unit 2 through the pulse width signal output PWM to control the driving unit 2 to supply power to the LED main lamp 3 with the active current in the provided midst level. So the LED main lamp 3 is lighted up in the midst lightness. If the data saved in the level indicating state flag storage cell is 01110, that is the fourth level state, the microprocessor control unit 6 transmits zero, which is the shortest Pulse Width Modulation signal, to the driving unit 2 through the pulse width signal output PWM to control the driving unit 2 to supply power to the LED main lamp 3 with the active current in the provided fourth level. So the LED main lamp 3 is lighted up in the sub-highest lightness. If the data saved in the level indicating state flag storage cell is 11110, that is the fifth level state, the microprocessor control unit 6 transmits steady high level VCC to the driving unit 2 through the pulse width signal output PWM to control the driving unit 2 to supply power to the LED main lamp 3 with the active current in the provided fifth level. So the LED main lamp 3 is lighted up in the highest lightness.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The present invention of a light adjustable lamp is provided with simple structure and clear function of each unit, which is easily for integrated circuit module. So the serving life and the reliability are promoted. Especially, with touch sensing keyboard to deal with the switch and the switch of the main lamp, the user sliding contacts or pressing contact the sensing keys with a finger to achieve the corresponding controlling and the sliding operation interface.

1. A light adjustable lamp includes a power module, a driving unit, a touch signal converter and a microprocessor control unit; the power module supplies power to the driving unit controlled by the Pulse Width Modulation signals, and the driving unit supplies power to the lamp; at the same time, the power module supplies power to the touch signal converter and the microprocessor control unit; the touch signal converter receives the sensing signal of on, off or level signals from the sensor key on the touch sensor keyboard; the microprocessor control unit analyses the control potential signal from the touch signal converter to transmit the corresponding Pulse Width Modulation signal to control the driving unit to cut off the power to the lamp or supply power to the lamp with active current in provided level.

2. The light adjustable lamp according to the claim 1, wherein further includes a level indicate unit, the power module supplies power to the level indicate unit, the microprocessor control unit transmits the current level signal to the level indicate unit to light up the corresponding indicator of the level indicate unit.

3. The light adjustable lamp according to the claim 1, wherein the touch signal converter is capacitive touch sense integrated circuit module.

4. The light adjustable lamp according to the claim 1, wherein the lamp is an LED lamp.

5. A light adjust manner for a lamp, the power module supplies power to the driving unit controlled by the Pulse Width Modulation signals, and the driving unit supplies power to the main lamp;
At the same time, the power module supplies power to the touch signal converter and the microprocessor control unit;
The touch signal converter receives the sensing signal of on, off or level from the sensor key of the touch sense keyboard, and converts the sensing signal to the corresponding level signal to transmit to the microprocessor control unit;
The microprocessor control unit analyses the control level signal from the touch signal converter, and transmits the corresponding Pulse Width Modulation signal to the driving unit to control the level indicate unit to light up the corresponding indicator of the level indicate unit.

6. The light adjust method for a lamp according to the claim 5, wherein the main lamp is powered and entered to the power-saving mode with actuating the microprocessor control unit intermittently.

7. The light adjust method for a lamp according to the claim 6, wherein the microprocessor control unit detects all of the self detect inputs to checkout that whether there is a touch signal, and transmits the corresponding Pulse Width Modulation signal to the driving unit to control the driving unit to cut off the power for the lamp or supply power to the lamp with active current in provided level.

8. The light adjust method for a lamp according to the claim 7, wherein the microprocessor control unit transmits the current level control signal to the level indicate unit to light up the corresponding indicate lamp of the indicate unit.

9. The light adjustable lamp according to the claim 2, wherein the touch signal converter is capacitive touch sense integrated circuit module.

10. The light adjustable lamp according to the claim 2, wherein the lamp is an LED lamp.
